(19) United States
(12) Patent Application Publication
(10) Pub. No.: US 2019/0354403 A1
(43) Pub. Date: Nov. 21, 2019

(54) DEPLOYING EMBEDDED COMPUTING ENTITIES BASED ON FEATURES WITHIN A STORAGE INFRASTRUCTURE

(71) Applicant: International Business Machines Corporation, Armonk, NY (US)

(72) Inventors: Phani Kumar V.U. Ayyagari, Hyderabad (IN); Sasikanth Eda, Vijayawada (IN); Krishnasuri Narayanam, Bangalore (IN); Sukumar Vankadhara, Bangalore (IN)

(21) Appl. No.: 15/983,308

(22) Filed: May 18, 2018

(51) Int. Cl. G06F 9/50; H04L 29/08; G06F 9/455; G06F 3/06; G06F 9/448

(52) U.S. Cl. CPC G06F 9/505; H04L 67/1097; G06F 2009/45575; G06F 3/0644; G06F 9/448; G06F 9/45558

(57) ABSTRACT

A method for managing an execution of a workload within a networked computing environment. The method includes at least one computer processor identifying a plurality of objects associated with a workload, the plurality of objects includes a first object. The method further includes identifying information corresponding to one or more one nodes that store an instance of the first object, where the information identifies features of a node. The method further includes identifying an embedded computing entity associated with processing at least the first object. The method further includes deploying an instance of the identified embedded computing entity to a first node that stores an instance of the first object based on information associated with features of the first node. The method further includes executing the workload utilizing the embedded computing entity.

### BACKGROUND OF THE INVENTION

The present invention relates generally to the field of data processing, and more particularly to deploying embedded computing entities to support a workload, within a storage system, based on hardware features of nodes of the storage system.

A workload (i.e., software workload) may be viewed as a self-contained unit consisting of an integrated stack consisting of applications, middleware, databases, and operating systems devoted to a specific computing task. A workload can be initiated by: a user; a software application, such as a script; a computing system; or a combination thereof. In some instances, an executing workload can spawn or generate additional child workloads or sub-workloads to support the operations of the parent workload, such as a business service.

Within various data centers, networked computing environments, and cloud computing architectures, workloads are comprised of and utilize a plurality of data and computing objects distributed among various hardware and software entities within the computing architecture. Some computing system architectures store data utilizing object-based storage. Object-based storage stores data as objects that include: the data itself, expandable metadata, which generates a “smart” data object, and a globally unique identifier utilized to find the object as opposed to a fixed file location. The metadata of smart data objects are information rich and can describe: the content of the data, relationships between the object and other objects, and constraints associated with the object, such as object security.

In an example architecture, object storage can be comprised of various types of entities or node groups. Proxy nodes are used to distribute workloads, handle workload requests within a namespace, and direct the transfer of objects that comprise the workload among nodes. Storage nodes are responsible for storing data (e.g., objects) and writing the data to storage subsystems. Compute nodes are utilized to process and analyze the data within the storage nodes to extract meaningful information from the raw data. A workload executing within an object-based storage architecture can interact with a plurality of nodes to produce a result.

### SUMMARY

According to embodiments of the present invention, there is a method, computer program product, and/or system for managing an execution of a workload within a networked computing environment. The method includes at least one computer processor identifying a plurality of objects associated with a workload, the plurality of objects include a first object. The method further includes identifying information corresponding to one or more one nodes that store an instance of the first object, where the information identifies features of a node. The method further includes identifying an embedded computing entity associated with processing at least the first object. The method further includes deploying an instance of the identified embedded computing entity to a first node that stores an instance of the first object based on information associated with features of the first node. The method further includes executing the workload utilizing the embedded computing entity.

### BRIEF DESCRIPTION OF THE DRAWINGS

FIG. 1 illustrates a networked computing environment, in accordance with an embodiment of the present invention.

FIG. 2a depicts an illustrative example of a matrix of information associated with nodes of an object-based storage system, in accordance with an embodiment of the present invention.

FIG. 2b depicts an illustrative example of a matrix of information associated with computational operations and features of nodes that enhance the performance associated with executing a given computational operation, in accordance with an embodiment of the present invention.

FIG. 3 depicts a flowchart of the operational steps of a workload deployment program, in accordance with an embodiment of the present invention.

FIG. 4 depicts an illustrative example of a deployment of embedded computing entities within nodes of an object-based storage system based on an example workload, in accordance with an embodiment of the present invention.

FIG. 5 depicts a flowchart of the operational steps of a workload analysis program, in accordance with an embodiment of the present invention.

FIG. 6 is a block diagram of components of a computer, in accordance with an embodiment of the present invention.

### DETAILED DESCRIPTION

Embodiments of the present invention recognize object-based storage can be implemented within: a data center, a networked computing environment, and/or a cloud computing architecture. Data objects, hereinafter are referred to as objects, include the intrinsic data of the object; corresponding expandable metadata, such as, but is not limited to: the content of the data, relationships between the object and other objects, a time and date, information associated with an originating application, keywords, and a globally unique identifier (ID). Copying or transferring objects from storage nodes to compute nodes to perform various operations, such as computations, queries, transactions; modifying objects; and returning results, increases the demands associated with network communications. In addition, communications internal to a node, such as accessing various storage devices, consumes additional memory and chipset resources (e.g., processor instructions and time). Embodiments of the present invention also recognize that within the object-based storage architecture, objects can be backed-up/protected by replication schemes, such as 3X replication. Further, the replicas of an object may be stored on nodes that differ in hardware configurations and capabilities. In addition, the distribution (i.e., locations) of objects may not be not fixed and can vary with time based on various system optimizations and the frequency of access of the objects.

Embodiments of the present invention recognize that one approach to improving the performance of a workload utilizing an object-based storage architecture is to deploy (e.g., assign or install copies/instances) of one or more embedded computing entities within various nodes of the object-based storage architecture to perform various tasks and transmit results. Network traffic is reduced by processing objects in place, as opposed to transferring objects to a compute node for processing. However, embodiments of the present invention also recognize that deploying embedded computing entities based on provisioned computing resources does not take advantage of other features of nodes that can improve the performance of the embedded computing entities, such as communication interfaces and storage devices. Some embodiments of the present invention utilize embedded computing entities to generate objects from raw data.

Embodiments of the present invention facilitate the processing and/or improve the performance of an executing workload by deploying embedded computing entities within nodes of the object-based storage architecture based on the features (e.g., hardware, software, and firmware) of a node and/or objects included within the node. Embedded computing entities can include a library of tasks, computational algorithms, executable procedures, and/or middleware that are hereinafter referred to as executable procedures. Various embedded computing entities may be dynamically uploaded and deployed without interrupting an ongoing workload. Embodiments of the present invention can deploy multiple embedded computing entities to a node utilizing various virtualization units, such as virtual machines, software containers, etc. that are instantiated within the node. Some embodiments of the present invention can identify communication interfaces that include additional enhancement features, such as graphics processing units, application-specific integrated circuits (ASICs), and/or field-programmable gate arrays (FPGAs), which are capable of being programmed with embedded computing entities or executable procedures. By utilizing a communication interface with enhancement features, embodiments of the present invention offload computations and other tasks to the communication interface, thus reducing the demands on the computing resources of a node.

Some embodiments of the present invention include control functions/commands that can inhibit an executable procedure within an embedded computing entity to ensure proper processing elements of a workload. In an example, an executable procedure within an embedded computing entity deployed to a proxy node is inhibited from processing an applicable in-transit object, thereby allowing the object to transfer to another node that has additional features, which improves the performance of the executable procedure or that includes other objects utilized by another embedded computing entity.

Embodiments of the present invention utilize middleware and/or system functions to identify the computing resources and features associated with a node (i.e., a storage node or a proxy node), such as the types and numbers of storage devices, and the type and number of communication interfaces/protocols, in order to determine the placement of embedded computing entities and related executable procedures utilized during the execution of a workload. Communication interfaces include, but are not limited to, network interface cards, host bus adapters, mass storage device adapters, I/O controllers, and controller hubs. Some communication interfaces can support multiple protocols, such as ATA over Ethernet (AoE), Ethernet, and Fibre Channel over Ethernet, thus enabling communication, access, and control among different storage systems. Other communication interfaces can support different types of storage devices, thus providing performance improvements to some devices, such as a NVMe interface improves the performance of solid-state drives (SSDs) relative to (serial advanced technology attachment) SATA interfaces. Embodiments of the present invention recognize that within a software-defined storage (SDS) infrastructure, multiple nodes may be configured within one physical system (e.g., rack, box); however, the nodes are not constrained to be homogeneous (i.e., nodes may have the different hardware configuration).

Embodiments of the present invention parse and analyze a workload to determine relationships between: objects, executable procedures included within embedded computing entities, and hardware resources of nodes within an object-based storage architecture; and subsequently determine a scheme for deploying embedded computing entities utilized to improve the performance of the workload. Other embodiments of the present invention can dictate how aspects of a workload execute, such as directing an execution path or whether a deployed embedded computing entity executes one or more executable procedures, delays the execution of an executable procedure, or transfers one or more objects associated with the workload to another node without executing an executable procedure.

One skilled in the art would recognize that by reducing or eliminating the need to transfer data from a storage node to a compute node during the execution of a workload, the overall ability of a computing system to generate results in a meaningful way is increased. In addition, by identifying particular communication interfaces, the performance of embedded computing entities is enhanced by reducing the overhead associated with locating and accessing data within a storage device and data moves through the communication fabric more efficiently. Further, by parsing a workload and determining the objects utilized by the workload, objects or copies of objects can be proactively aggregated among nodes based on the features and configurations of the nodes, thus improving the execution of the workload. As such, the functioning of such a computing system and/or a computing environment is seen to be improved in at least these aspects. In addition, reducing or eliminating the need to transfer data from various nodes to a compute node during the processing of a workload reduces the wear-and-tear on various portions of the networked computing environment and reduces the network bandwidth demands by the workload, thus reducing potential network constraints for other users. By placing an embedded computing entity and related objects within nodes of the object-based storage architecture as opposed to copying objects to a compute node, the exposure of objects across a network is reduced, thus improving security.

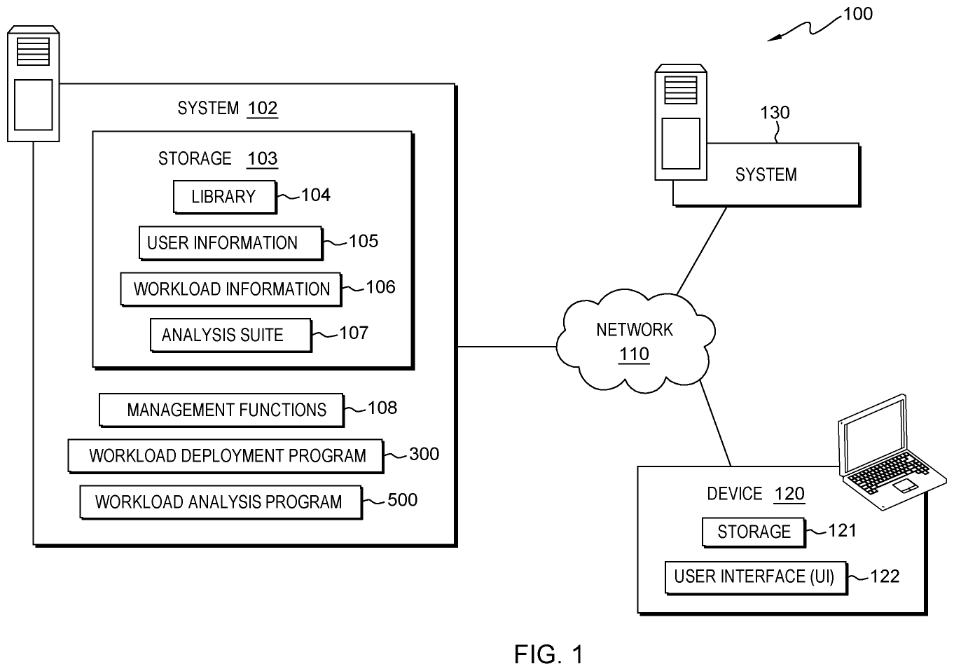

The present invention will now be described in detail with reference to the Figures. FIG. 1 is a functional block diagram illustrating networked computing environment 100, in accordance with embodiments of the present invention. In an embodiment, networked computing environment 100 includes: system 102, device 120, and system 130, all interconnected over network 110. In some embodiments, networked computing environment 100 includes multiple instances of system 130. Many modifications to the depicted environment may be made by those skilled in the art without departing from the scope of the invention as recited by the claims.

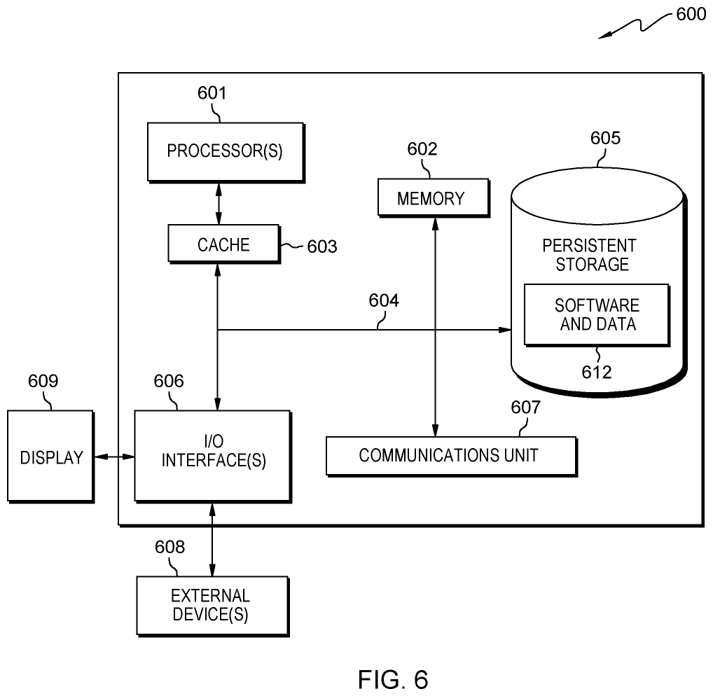

System 102, device 120, and system 130 may be: laptop computers, tablet computers, netbook computers, personal computers (PC), desktop computers, personal digital assistants (PDA), smartphones, wearable devices (e.g., digital eyeglasses, smart glasses, smart watches, personal fitness devices), or any programmable computer systems known in the art. In certain embodiments, system 102 and system 130 represent computer systems utilizing clustered computers and components (e.g., database server computers, application server computers, storage systems, etc.) that act as a single pool of seamless resources when accessed through network 110, as is common in data centers and with cloud-computing applications. In general, system 102 and system 130 are representative of any programmable electronic device or combination of programmable electronic devices capable of executing machine readable program instructions and communicating with device 120 via network 110. System 102, device 120, and system 130, may include components, as depicted and described in further detail with respect to FIG. 6, in accordance with embodiments of the present invention.

System 102 includes: storage 103, management functions 108, workload deployment program 300, workload analysis program 500 and various programs and databases (not shown), such as firmware, a hypervisor, and a load balancer. In various embodiments, system 102 utilizes network 110 to access other computing systems (not shown) that include other programs and/or services utilized to process, analyze, and parse a workload. Storage 103 includes: library 104, user information 105, workload information 106, and analysis suite 107. Storage 103 may also include various other files, tables, databases, etc. Storage 103 may include various programs and databases, such as a web interface, a database management system, a multi-path communication program (not shown). In some embodiments, storage 103 includes a combination of persistent storage devices, such as non-volatile memory (e.g., NVRAM), SSDs, hard-disk drives (HDDs), and archival media (e.g., tape storage).

Library 104 includes information organized within various tables, matrixes, and databases. Information within library 104 may be shareable among users of system 102. In an embodiment, library 104 includes: virtual machine (VM) templates; VM appliances; Docker™ files; containers; executable binary software entities; and image files of various embedded computing entities, such as storlets. In various embodiments, library 104 includes a plurality of executable procedures utilized to create, or for inclusion in embedded computing entities. Embedded computing entities and the included executable procedures can be: written by a system administrator, written by a user, purchased (e.g., licensed) from a third-party software developer, and/or created by a computing system that generates a workload. For example, a cognitive system can compile various executable procedures and create one or more embedded computing entities optimized for processing portions of a workload that is created in response to a query by a user. In an embodiment, an embedded computing entity can also include: generic functions, logic, and/or complex data processing that can be utilized by multiple applications. In other embodiments, the execution of embedded computing entities is integrated with other applications that support representational state transfer. In addition, some embedded computing entities can call or execute other embedded computing entities or spawn a sub-workload.

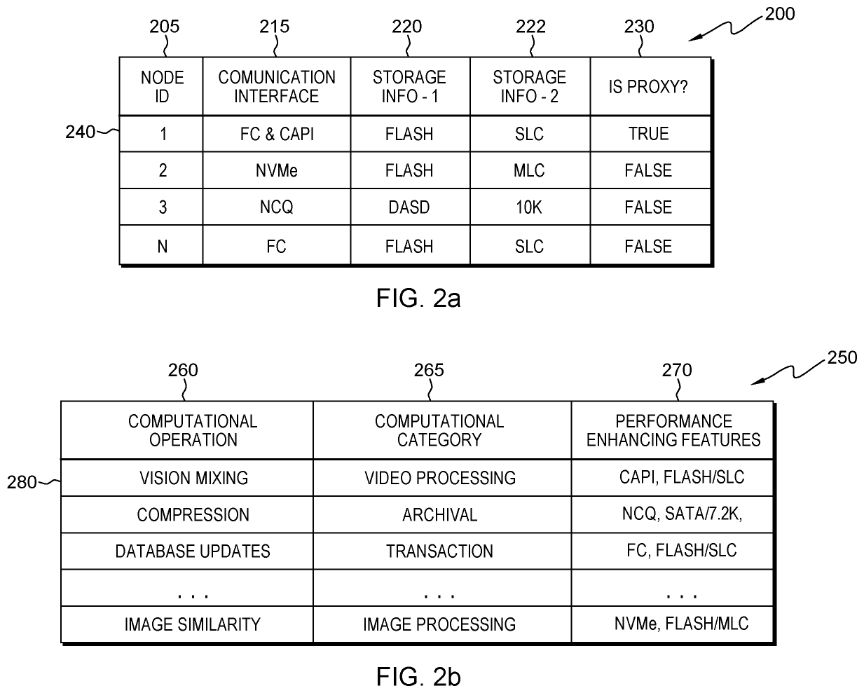

In various embodiments, library 104 includes one or more instances of table 200 (described in further detail with respect to FIG. 2a) and/or cross-references to instances of table 250. Historic instances of table 200 may be maintained to track changes to networked computing environment 100, and/or performance changes associated with various embedded computing entities. Cross-references within various instances of table 250 can associate a computational operation with one or more embedded computing entities. Another instance of table 200 may be a recent snapshot of the hardware and configuration of networked computing environment 100. In another embodiment, library 104 includes a system-generated instance of table 250 (described in further detail with respect to FIG. 2b). In some embodiments, the information, metadata, and cross-references associated with instances of table 200 and table 250 are maintained in a database.

User information 105 includes: tables, associative arrays, and databases that are associated with: user accessible (e.g., licensed) embedded computing entities, object types processed by executable procedures, computation algorithms and executable procedures included within embedded computing entities, workload descriptions, one or more user-defined instances of table 250, etc. In addition, user information 105 includes object classification data associated with a workload to reduce the overhead of reclassifying objects during subsequent executions of the workload. User information 105 can also include various user preferences, such as workload priorities, workload costing information (e.g., constraints, over-budget parameters, criterion, etc.), resource allocations/constraints for embedded computing entities, etc.

In some embodiments, user information 105 may include conditions (e.g., primary criteria, secondary criteria, threshold levels/criteria, etc.), event/operational hierarchies, optimization schemes, etc., that enable a workload, utilizing the present invention, to access and/or execute one or more additional embedded computing entities of networked computing environment 100 without user intervention. For example, a user may define a threshold level of features as a set of features that enhances the execution of an embedded computing entity by at least 60% of the historic average performance for a defined set of features. In another example, a threshold number of object may be a number or volume of data within a node or a cluster of nodes within one proxy node or network link. In some instances, if a threshold of objects associated with a portion of a workload is not identified, then an embedded computing entity may not be deployed. In various embodiments, user information 105 includes performance data associated with various workloads, embedded computing entities, and/or executable procedures utilized during the processing of a workload for each deployment/optimization scheme utilized.

Workload information 106 includes various elements, such as tables, associative arrays, and databases that are associated object types (e.g., text, image, audio, tables, etc.), which are processed by embedded computing entities; executable procedures included within an embedded computing entity; storage locations or unique IDs of objects; access paths to storage devices/systems; objects utilized by a workload; etc. In some embodiments, workload information 106 includes monitoring data, such as traffic information associated with network 110, a status of various instances of system 130, and/or information associated with the execution and/or performance of various workloads obtained by various aspects of management functions 108 and/or software daemons (i.e., background processes). Workload information 106 may also include historic data associated with previous executions of a workload, such as performance data, computing resource utilization, latency or bandwidth information related to portions of network 110, data clustering models, storage partitioning models, embedded computing entities, etc. Performance data may be associated with a deployment or optimization scheme utilized for various workloads, one or more embedded computing entities, and/or various executable procedures utilized during the executions of a workload, etc.

In one embodiment, workload information 106 includes information associated with the executable procedures utilized to process objects associated with a workload as opposed to specific embedded computing entities. In an example, workload information 106 may include generalized information for classifying an object based on information within an instance of table 250, which can be utilized to dynamically create embedded computing entities from a library of executable procedures as opposed to utilizing pre-defined embedded computing entities. In various embodiments, workload information 106 is accessed by workload deployment program 300 to obtain information associated with a workload, such as a list of objects processed by an embedded computing entity and classifications assigned to a plurality of objects. In one scenario, one or more elements of workload information 106 are updated based on input by a user. In another scenario, one or more elements of workload information 106 are updated by an instance of workload analysis program 500. In various scenarios, a user may dictate whether classification information of objects determined during the execution of a workload is included in workload information 106 for sharing among users of system 102 as opposed to storing the classification information of objects within user information 105.

Analysis suite 107 includes various programs, functions, and applications utilized to parse a workload, process a workload, and/or determine storage locations for intermediate results generated during an execution of the workload. Analysis suite 107 may be executed/called at the proxy layer or invoked as middleware. Analysis suite 107 includes, but is not limited to: analytic functions, clustering functions, graph database analysis tools, graph partitioning programs, visualization programs, simulation programs, machine learning programs, etc. In another embodiment, one or more programs, functions, and applications of analysis suite 107 are purchased (e.g., licensed) as-a-service and are accessible via network 110.

In some embodiments, analysis suite 107 includes one or more cognitive functions or APIs (application programming interfaces) that can parse and analyze a workload. In other embodiments, users utilizing system 102 have access to one or more aspects of analysis suite 107. In an example, analysis suite 107 includes a visualization program, such as Visual Insights™ that enables a user to obtain a visual representation of a workload that includes object placement (e.g., node locations), embedded computing entity placement, and object/node clustering's. In addition, the visualization representation can depict: computing resource utilization, network traffic, data processing delays, critical paths/nodes, etc. In various embodiments, analysis suite 107 includes one or more cognitive functions, cognitive APIs, and classification programs utilized to analyze an object of a workload to identify a computational operation or a related executable procedure that is utilized to process the object. An aspect of analysis suite 107 can classify an object based on: metadata information, header information, analyzing the content of the object and/or analyzing the structure of the object.

Management functions 108 includes but is not limited to: a load balancing program, a visualization program, monitoring functions that monitor the resources and performance of various aspects of networked computing environment 100, tools that monitor the performance of portions (e.g., routers, switches, nodes, communication paths, etc.) of network 110, and a security/resource control program. In an embodiment, a function of management functions 108 identifies objects, determines locations of objects, and/or constrains which nodes may store an object. Management functions 108 also includes functions and programs that determine the configurations (e.g., hardware and software features) of proxy nodes, compute nodes, storage entities, and/or storage nodes within networked computing environment 100. In an example, management functions 108 determine the communication interfaces and storage devices of nodes and other computing resources, available and/or allocated, such a number of CPUs, GBs of volatile memory, graphics processing units (GPUs), FPGAs, accelerator cards, etc.

In some embodiments, one or more aspects of management functions 108 periodically polls, aggregates, compiles and/or verifies information included within one or more instances of table 200. In other embodiments, management functions 108 deploys (e.g., installs) a software daemon within various instances of system 130 and/or each node within an instance of system 130 to determine configuration information associated with each node that stores data objects. In response to a deployment, configuration change, or instantiation of a node within networked computing environment 100, a software daemon transmits new or updated configuration information of the node to system 102 for inclusion in or updating of an instance of table 200. In various embodiments, the information within one or more instances of table 200 is obtained and maintained utilizing a combination of aspects of management functions 108 and software daemons deployed to nodes or instances of system 130 that store data objects.

Workload deployment program 300 is program that deploys embedded computing entities among nodes of an object-based storage architecture to enhance the performance of a workload and subsequently executes the workload. Workload deployment program 300 deploys various embedded computing entities within nodes of networked computing environment 100 based on placement of objects and features of nodes to improve the performance of an executing workload and reduce the number of compute nodes. In an embodiment, workload deployment program 300 is middleware installed on system 102. In some embodiments, workload deployment program 300 dictates whether an object is processed by an embedded computing entity or whether the object is communicated to another node. In an example, if workload deployment program 300 identifies that multiple replicas of an object are stored on different nodes, then workload deployment program 300 can direct the placement of embedded computing entities and an execution path for a portion of a workload to nodes that store a replica of an object. In other embodiments, workload deployment program 300 responds to constraints identified within networked computing environment 100 by identifying other schemes for deploying embedded computing entities and manipulating objects among nodes.

Workload analysis program 500 is a program that parses a workload to identify various workflows (e.g., portions, sub-workloads) within the workload, identifies information related to the objects associated with the workload, and determines various characteristics for each portion of the workload. Workload analysis program 500 may store classifications of objects and characteristics associated with portions of a workload within workload information 106, user information 105, and/or library 104. In one embodiment, workload analysis program 500 accesses a set of information related to processing a workload, such as a list of embedded computing entities utilized to process various portions of the workload, current locations for objects associated with a workload, a list of intermediate results generated by portions of the workload and information generated by a prior instance of workload analysis program 500 that parsed the workload. In another embodiment, workload analysis program 500 executes offline to analyze a workload. In one scenario, workload analysis program 500 initiates to analyze a workload in response to a user of device 120 uploading an instance of table 250 and a set of related embedded computing entities to system 102. The user may utilize a result generated by workload analysis program 500 to develop optimization schemes for the workload. In another scenario, workload analysis program 500 executes offline to analyze an execution of a workload after the workload executes to determine whether each portion of the workload was analyzed.

In some embodiments, workload analysis program 500 parses a workload, to identify objects and relationships of objects associated with the workload and further to determine the executable procedures and related computing entities that can potentially improve the performance of executing the workload. In various embodiments, multiple instances of workload analysis program 500 can execute to analyze the workload. In an example, a user submits a query that generates a graph workload that includes various sub-workloads. A first instance of workload analysis program 500 may parse the graph workload and determine that two sub-workloads include information and/or data structures that can utilize embedded computing entities to improve processing of the workload. In response, workload analysis program 500 initiates two additional instances of workload analysis program 500 to parse and analyze each of the determined sub-workloads that can utilize embedded computing entities

In one embodiment, system 102 communicates through network 110 to device 120, and one or more instances of system 130. Network 110 can be, for example, a local area network (LAN), a telecommunications network, a wireless local area network (WLAN) (e.g., an intranet), a wide area network (WAN), the Internet, or any combination of the previous and can include wired, wireless, or fiber optic connections. In general, network 110 can be any combination of connections and protocols that will support communications between system 102, device 120, and system 130, in accordance with embodiments of the present invention. In some scenarios, system 102 utilizes network 110 to access one or more instances of system 130. In another embodiment, network 110 operates locally via wired, wireless, or optical connections and can be any combination of connections and protocols (e.g., personal area network (PAN), near field communication (NFC), laser, infrared, ultrasonic, etc.).

In some embodiments, a portion of network 110 is representative of a virtual LAN (VLAN) within a larger computing system that includes at least one instance of system 102 and/or at least one instance of system 130. In other embodiments, a portion of network 110 is representative of a virtual private network (VPN) that a user of device 120 can utilize to communicate with system 102 and/or one or more instances of system 130. In a further embodiment, system 102 may utilize a traffic monitoring program (not shown) to monitor a portion of network 110 to identify information and/or metadata that identifies a workload that utilizes one or more embedded computing entities.

System 130 is representative of one or more storage systems within networked computing environment 100 that are part of an object-based storage architecture. In an embodiment, system 130 includes a plurality of communication interfaces, storage devices, and various programs and databases (not shown), such as a hypervisor, a storage tiering program, and a virtualization program. In various embodiments, system 130 includes one or more internal instances of network 110 that interconnect the plurality of nodes within an instance of system 130. In one embodiment, an instance of system 130 is comprised of a plurality of storage nodes and proxy nodes. In another embodiment, an instance of system 130 utilizes an SDS architecture to dynamically create storage nodes and proxy nodes. In other embodiments, various instances of system 130 (e.g., physical and/or software-defined) are distributed within a cloud computing environment, such as within a portion of: a public cloud, a private cloud, and a hybrid cloud. Instances of system 130 may be distributed among disparate physical or geographic locations.

In some embodiments, an instance of system 130 is comprised of a combination of physical and virtualized computing resources, such as persistent storage devices, non-volatile memory (e.g., flash memory), volatile memory, CPUs, GPUs, FPGAs, encryption/decryption hardware, communication interfaces, etc. In addition, storage devices and communication interfaces include capabilities that can provide performance benefits (e.g., value add) with respect to various elements of an executing workload. Some examples of communication interfaces and related elements that provide a performance benefit for various tasks (i.e., computational operations) are: SATA for data archival; FC (Fibre channel) for transactional operations; CAPI (coherent accelerator processor interface) for video streaming, simulations, and No-SQL operations; and NVMe (non-volatile memory express host controller) for pipelined operations. Storage device technologies can also provide performance benefits for various workload elements. Some examples of storage device technologies are: SLC (single-level cell NAND flash) for transaction operations; MLC (multi-level cell NAND flash) for images, non-frequent accessed operations; TLC (triple-level cell NAND flash) for transaction operations; NCQ (native command queuing on SATA drives) for multi-threaded/multi-process operations. Similarly, other aspects of a storage device can affect performance of a workload, such as drive capacity, rotational speed, cache size, embedded firmware, and/or storage organization.

Device 120 includes: storage 121 and user interface (UI) 122. Storage 121 may include an operating system for device 120 and various programs and databases (not shown), such as a web browser, an e-mail, a database program, a programming environment for developing embedded computing entities and executable procedures, etc. Storage 121 may include one or more user-defined instances of table 250 and a database of embedded computing entities and executable procedures. One or more programs stored on device 120 and/or one or more programs accessible via network 110, generate workloads that execute within networked computing environment 100. In some embodiments, storage 121 includes a local version of user information 105, workload information 106, and one or more instances of table 200 and table 250 from system 102. In various embodiments, storage 121 also includes a list of embedded computing entities accessible (e.g., purchased, licensed, etc.) by a user of device 120, in which security certificates correspond to embedded computing entities, and/or the configuration files of one or more embedded computing entities utilized by the user of device 120.

A user of device 120 can interact with UI 122 via a singular interface device, such as a touch screen (e.g., display) that performs both as an input to a graphical user interface (GUI) and as an output device (e.g., a display) presenting a plurality of icons associated with software applications or images depicting the executing software application. Optionally, an app, such as a web browser, can generate UI 122 operating within the GUI of device 120. In some embodiments, device 120 includes various input/output (I/O) devices (not shown), such as a digital camera, a speaker, a digital whiteboard, and/or a microphone. UI 122 accepts input from a plurality of input/output (I/O) devices including, but not limited to, a tactile sensor interface (e.g., a touch screen, a touchpad), a natural user interface (e.g., a voice control unit, a camera, a motion capture device, eye tracking, etc.), a video display, or another peripheral device. An I/O device interfacing with a UI 122 may be connected to an instance of device 120, which may operate utilizing a wired connection, such as a universal serial bus port or wireless network communications (e.g., infrared, NFC, etc.). For example, an I/O device may be a peripheral, such as a keyboard, a mouse, a click wheel, or a headset that provides input from a user.

In an embodiment, UI 122 may be a graphical user interface (GUI) or a web user interface (WUI). UI 122 can display text, documents, web browser windows, user options, application interfaces, and instructions for operation; and include the information, such as graphics, text, and sounds that a program presents to a user. In some embodiments, a user of device 120 can interact with UI 122 via a singular device, such as a touch screen (e.g., display) that performs both as an input to a GUI/WUI, and as an output device (e.g., a display) presenting a plurality of icons associated with apps and/or images depicting one or more executing software applications. In other embodiments, a software program can generate UI 122 operating within the GUI environment of device 120. In various embodiments, UI 122 may receive input in response to a user of device 120 utilizing natural language, such as written words or spoken words, that device 120 identifies as information and/or commands. In addition, UI 122 may control sequences/actions that the user employs to initiate a workload within networked computing environment 100. In other embodiments, a user of device 120 utilizes UI 122 to: update/modify user information 105, update/modify workload information 106, interface with workload deployment program 300, and/or interface with workload analysis program 500.

FIG. 2a depicts an example of table 200, in accordance with an embodiment of the present invention. In some embodiments, instances of table 200 are included in a database of system 102. Table 200 illustrates information, such as hardware features related to a plurality of nodes of one or more instances of system 130, distributed within networked computing environment 100. In an embodiment, an instance of table 200 includes information associated with a group of nodes of an object-based storage architecture as illustrated within columns 205, 215, 220, 222, and 230. Each row includes configuration information corresponding to a node. Column 205 corresponds to an identifier (i.e. an ID) for a node. Column 215 corresponds to one or more types of communication interfaces configured for a node. Column 220 includes information related to the storage media (storage info-1) within a node, such as NVRAM; flash (i.e., SSDs); DASD (i.e., HDDs); and/or archival media (i.e., tape storage). Column 222 includes additional information (storage info-2) related to a type of storage media corresponding to an element of column 220, such as the flash-memory type (e.g., SLC, MLC, TLC); DASD speed (e.g., 7.2K rpm, 10K rpm, 15K rpm); and tape type (e.g., linear tape-open (LTO™)). Column 230 indicates whether a node is configured for utilization as a proxy node. For example, row 240 indicates that node 1 includes two different types of communication interfaces FC and CAPI, storage info-1 is FLASH, the type of flash is SLC, and node 1 is also a proxy node.

In a further embodiment, elements of table 200 include additional metadata that further describes one or more aspects of an element, such as an IP address associated with a node ID. Row 240 indicates that node 1 includes FC and CAPI communication interfaces that can further include metadata, such as a corresponding speed/bandwidth; a number of instances of each type of communication interface; supported communication protocols; one or more port IDs respectively associated with an instance of a communication interface; and an information related to embedded firmware and/or accelerators of a communication interface, such as an encryption accelerator, a GPU, and/or a FPGA. Similarly, metadata associated with storage info-1 may include information, such as a storage capacity and a utilization percentage.

FIG. 2b depicts an example of table 250 illustrating information related to a plurality of computational operations and features of a plurality of nodes that can improve the performance of computational operations associated with embedded computing entities, in accordance with an embodiment of the present invention. In some embodiments, instances of table 250 are included in a database of system 102. In an embodiment, table 250 cross-references a set of features (e.g., communication interfaces, storage devices, protocols, etc.) as depicted in column 270 with general computational categories in column 265, and related computational operations (i.e., task) in column 260. In an example, a general computational category is image processing, related computations operations included: color correction, amination, steganography, and image comparison. In another embodiment, if a specific computational operation is not defined for an element of column 260, then the information within column 265 is used to identify features utilized to identify possible nodes for embedded computing entity deployment. Various embodiments of the present invention utilize information within table 250 and table 200 to identify nodes within which to deploy embedded computing entities to improve the performance of an executing workload that utilizes an object-based storage architecture. In other embodiments, another instance of table 250 includes information (not shown) that cross-references one or more embedded computing entities that include a computational operation identified as related to an element of column 260.

In one embodiment, information within an instance of table 250 is compiled by a user and access is controlled by the user. In another embodiment, groups users of networked computing environment 100 share information utilized by system 102 to generate a different instance of table 250. In an example, members of a development project share access to an instance of table 250. In another example, another instance of table 250 is generated and accessed “as-a-service” within a collaborative environment. In some embodiments, system 102 monitors the execution of a plurality of workloads and embedded computing entities to determine various performance metrics, such as execution durations, CPU usage, RAM usage, storage usage, input/output operations per second (IOPS), network bandwidth, etc. and utilizes machine learning to generate instances of table 250.

In a further embodiment, the information within an instance of table 250 includes a hierarchy of features (e.g., preferences, quantifiable attributes), related to the elements of column 270, that enhance the execution of an embedded computing entity or one or more executable procedures deployed to a node to varying degrees. In an example, an instance of row 280 may include sets of ranked features within a corresponding element associated with column 270. In this example, a video mixing embedded computing entity may utilize a primary set of features of: CAPI and FLASH/SLC (e.g., a performance advantage); and an alternative set of features of: NVMe and Flash/MLC (e.g., a reduced performance advantage).

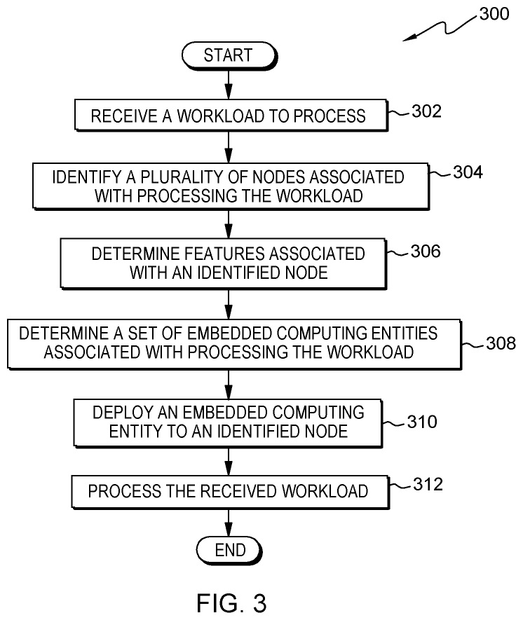

FIG. 3 is a flowchart depicting operational steps for workload deployment program 300, a program that deploys embedded computing entities among nodes of networked computing environment 100 to enhance the performance of an executing workload, in accordance with an embodiment of the present invention. In various embodiments, multiple instances of workload deployment program 300 execute concurrently. In some embodiments, workload deployment program 300 interfaces with instances of workload analysis program 500.

In step 302, workload deployment program 300 receives a workload to process. In one embodiment, workload deployment program 300 receives a workload based on system 102 acting as an administrative system that distributes workloads among a plurality of nodes (not shown) included in various instances of system 130 of networked computing environment 100. Workloads may be initiated by a user of device 120, another computing system (not shown), and/or an executing software program. In various embodiments, additional instances of workload deployment program 300 receive sub-workloads (i.e., child workloads) to process that are generated during the execution of the initial (i.e., parent) workload. In another embodiment, an instance of workload deployment program 300 receives a sub-workload that is dynamically generated during the execution of an embedded computing entity.

In some embodiments, workload deployment program 300 identifies objects associated with a workload while the workload is in progress. Workload deployment program 300 may utilize an aspect of analysis suite 107 to classify objects associated with a workload. In some scenarios, workload deployment program 300 classifies objects associated with a workload based on content, metadata, user specified information, etc. In other scenarios, workload deployment program 300 may classify an object based on a general computational category associated with an object, such as text format conversion, image processing, software compiling, encryption, etc. In other embodiments, workload deployment program 300 interfaces with workload analysis program 500 to analyze or parse a new workload/sub-workload or a workload/sub-workload not previously parsed or analyzed to determine various characteristics of a workload, such as classifications of objects associated with the workload or constraints.

In step 304, workload deployment program 300 identifies a plurality of nodes associated with processing the workload. Workload deployment program 300 identifies nodes associated with an object-storage architecture within networked computing environment 100, such as within one or more instances of system 130. Workload deployment program 300 can identify nodes distributed among disparate physical or geographic locations, such as within a cloud-computing environment. Workload deployment program 300 identifies a plurality of nodes that: store, copy, transfer, migrate, and/or process objects associated with the workload, including nodes that store replicas of objects. In addition, workload deployment program 300 identifies nodes associated with the workload that store, process, and/or transfer one or more results generated during the execution of the workload and/or one or more sub-workloads. In one embodiment, workload deployment program 300 performs a lookup operation (e.g., a query, a cross-reference) of workload information 106 and/or user information 105 to identify information related to the plurality of nodes associated with processing the workload and information related to the locations of objects based on historical information. In another embodiment, workload deployment program 300 utilizes one or more aspects of management functions 108 to obtain information related to the plurality of nodes associated with processing the workload and information related to the locations of objects associated with the workload.

In some embodiments, workload deployment program 300 identifies a portion of a workload that utilizes a proxy node to process and/or create objects as opposed to transferring or storing pre-existing objects. In response, workload deployment program 300 identifies a node that includes one or more features that support an embedded computing entity to process and/or create objects utilized by the workload. In an example, workload deployment program 300 identifies a node that receives non-object-based data and deploys an embedded computing entity to the node to extract and filter information for conversion to objects. Alternatively, such as within an SDS architecture, workload deployment program 300 can communicate with system management functions 108 to provision one or more nodes with the one or more features that support various embedded computing entities.

In step 306, workload deployment program 300 determines a set of features associated with an identified node. In one embodiment, workload deployment program 300 determines a set of features for each node that stores objects utilized by a workload. Workload deployment program 300 may also identify metadata related to one or more features of each identified node. Some hardware features, such as the communication interfaces and storage devices are obtained from one or more instances of table 200 within library 104. Other features/information associated with nodes utilized by a workload may be included within different tables and/or databases associated with system 102; or obtained utilizing one or more aspects of management functions 108, such as determining computing resource configurations, utilizations, and availabilities. In another embodiment, workload deployment program 300 can determine a set of features for each node that transfers objects utilized by the workload, and/or various results generated during the execution of a workload. In various embodiments, workload deployment program 300 determines other information associated with a plurality of nodes and networked computing environment 100, such as identifying availability of a node, computing resource utilization of a node, network traffic and delays among nodes utilized by a workload.

In step 308, workload deployment program 300 determines a set of embedded computing entities associated with processing the workload. Similarly, workload deployment program 300 can determine a set of embedded computing entities associated with processing a sub-workload. In one embodiment, workload deployment program 300 identifies a set of embedded computing entities that are utilized by the workload based on information received with the workload. In some scenarios, workload deployment program 300 receives one or more embedded computing entities with the received workload. In various scenarios, workload deployment program 300 accesses workload information 106 to identify a set of embedded computing entities that are utilized by the workload. In other scenarios, workload deployment program 300 identifies one or more embedded computing entities utilized by a workload based on cross-referencing or querying object metadata (e.g., classifications) with information within libraries 104 and/or user information 105, such as various instances of table 250.

In some embodiments, if workload deployment program 300 cannot identify one or more computing entities utilized by a workload, then workload deployment program 300 interfaces with workload analysis program 500 to identify embedded computing entities that are utilized by the workload. In addition, workload deployment program 300 can identify the features of a node related to executing an embedded computing entity. Alternatively, workload deployment program 300 can identify a set of features for each executable procedure within an embedded computing entity.

In a further embodiment, workload deployment program 300 compiles or updates one or more embedded computing entities from a plurality of executable procedures within library 104. In an example, in response to workload deployment program 300 determining that objects processed by different computation operations are stored within one node, workload deployment program 300 can reduce the number of embedded computing entities deployed to the node by updating (e.g., customizing) a copy of an embedded computing entity to include additional executable procedures. In other embodiments, workload deployment program 300 identifies one or more objects of a workload that are not processed by an embedded computing entity. Therefore, in some scenarios, workload deployment program 300 interfaces with workload analysis program 500 to determine characteristics of a portion (e.g., one or more objects) of the workload that is not processed by an embedded computing entity. Additionally, in another scenario, workload deployment program 300 flags the identified one or more objects that are not processed by an embedded computing entity for migration to nodes that include objects processed by embedded computing entities. In an example, workload deployment program 300 utilizes an aspect of analysis suite 107, such as a clustering algorithm to migrate flagged objects to nodes to: improve a response time, reduce cost, avoid delays related to a load balancer, and/or to reduce network latencies.

In step 310, workload deployment program 300 deploys an embedded computing entity to an identified node. In one embodiment, workload deployment program 300 deploys one or more embedded computing entities to a node based on features associated with an identified node that stores an object and information associated with an object, such as instances of table 200 and table 250. In some embodiments, workload deployment program 300 deploys one or more embedded computing entities to other nodes. In one scenario workload deployment program 300 determines that an object is stored on a node that does not include a primary set of features, and that migrating the object would not affect the execution of the workload. In response, workload deployment program 300 deploys another embedded computing entity to another node based on hierarchical alternatives, reducing delays, and/or clustering objects to improve performance. In another scenario, workload deployment program 300 deploys additional embedded computing entities to other nodes that include replicas of objects to support alternate execution paths for the workload based on the utilization of nodes by other workloads. In another embodiment, workload deployment program 300 deploys one or more embedded computing entities to proxy nodes that transfer objects, create objects, and/or transfer results of other embedded computing entities.

In various embodiments, workload deployment program 300 can customize a copy of an embedded computing entity prior to deploying the embedded computing entity. In other scenarios, if workload deployment program 300 determines that a communication interface of a node includes an FPGA, then workload deployment program 300 can program the FPGA with one or more executable procedures utilized to process objects associated with the node.

In a further embodiment, if workload deployment program 300 determines, based on criteria within user information 105, that a threshold (e.g., number, storage quantity (i.e., giga-bytes), etc.) of objects are not stored on nodes that include features that improve the execution of a threshold number of embedded computing entities and various criteria are met, then workload deployment program 300 submits a request via management functions 108 to provision one or more nodes. Workload deployment program 300 copies or migrates a set of objects to the one or more provisioned nodes and deploys the related embedded computing entities to the provisioned nodes. In an example, workload deployment program 300 utilizes analysis suite 107 to execute one or more simulations of a workload to develop a deployment scheme for embedded computing entities that optimize the execution of workload as opposed to optimizing the selection of nodes for each object and a related embedded computing entity.

In step 312, workload deployment program 300 processes the received workload. Workload deployment program 300 can transmit the output of the workload to one or more entities associated with the received workload, such as a user, another workload, another computing system and/or application, or a combination thereof. Workload deployment program 300 processes the results based on attributes and/or commands associated with the received workload. In one embodiment workload deployment program 300 processes the received workload based on the locations of objects and deployment of embedded computing entities. In another embodiment, workload deployment program 300 utilizes aspects of management functions 108 to monitor the performance information associated with the executing workload and to store the information within workload information 106 and/or user information 105) in addition to processing the received workload.

In some embodiments, workload deployment program 300 specifies or directs the execution (e.g., path) of a portion of a workload based on various criteria, such as an availability of computing resource within nodes, execution delays, and/or identifying a set of nodes that enhance the performance of embedded computing entities for an aggregation of objects as opposed to identifying a set of nodes that enhance the performance of embedded computing entities for individual objects. In addition, workload deployment program 300 can direct the execution of a portion of the workload to one or more nodes provisioned for the workload.

In some scenarios, workload deployment program 300 utilizes logical controls to activate or inhibit the execution of executable procedures within an embedded computing entity based on constraints, operational hierarchies, and execution sequences associated with the workload. In an example, workload deployment program 300 inhibits an embedded computing entity deployed to a proxy node from responding to the transfer of objects associated with the processing of a sub-workload; however, the embedded computing entity executes in response to transferring the results generated by the sub-workload. In another example, workload deployment program 300 inhibits an embedded computing entity from executing an executable procedure and directs the execution to the executable procedure programmed to an accelerator within the node.

In another example, in response to determining that a sequence of pipelined operations is executing for a set of objects, an embedded computing entity is inhibited from affecting the set of objects until the sequence of pipelined operations completes. In other scenarios, workload deployment program 300 determines whether to utilize a set of alternative nodes and/or embedded computing entities or to delay execution of a portion of a workload until nodes with a threshold set of features or computing resources are available. In an example, workload deployment program 300 determines whether to delay executing a portion of a workload on one set of nodes or to direct the execution of the portion of the workload to an alternate set of nodes and related embedded computing entities based on information obtained from a load balancer (i.e., a reverse proxy that distributes network or application traffic across a number of servers to increase capacity and reliability of applications). In an example, if workload deployment program 300 determines that based on the information from the load-balancer that one set of nodes is unavailable for at least 20 seconds, then workload deployment program 300 directs the execution of the portion of the workload that utilizes the one set of nodes to execute on a different set of nodes.

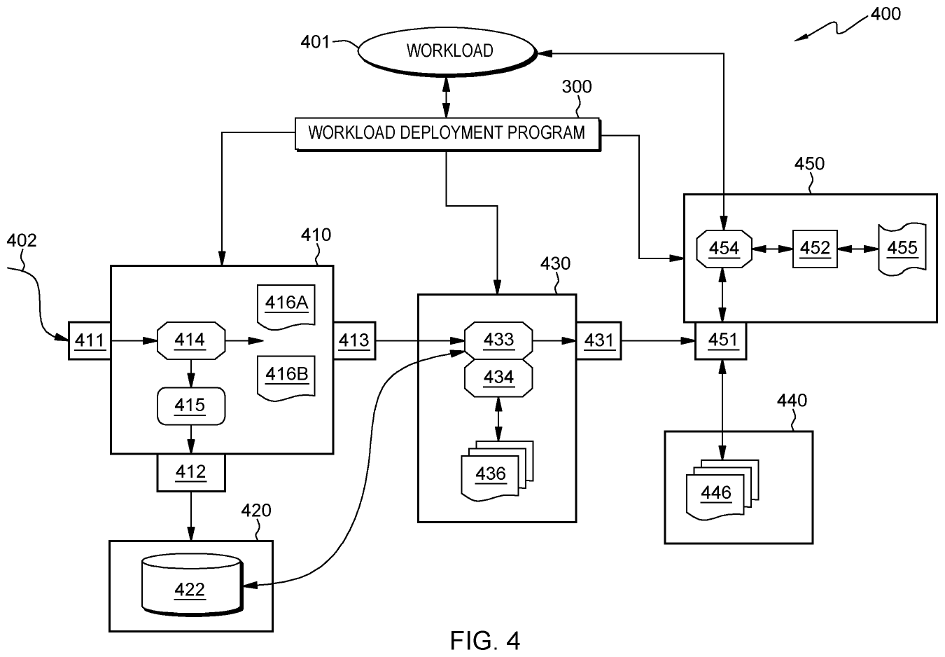

FIG. 4 depicts illustrative example 400 associated with deploying embedded computing entities within nodes of an object-based storage system of network computing environment 100 to support the execution of workload 401, in accordance with an embodiment of the present invention. Example 400 includes workload 401; an instance of workload deployment program 300; nodes 410, 420, 430, 440, and 450 that include one or more objects utilized by workload 401; and indications of some features of three nodes (i.e., nodes 410, 430, and 450) that can improve the execution of workload 401. Instances of single and/or double headed arrows indicate various communication paths that may include hardware cables, internal buses, and/or network communications related to one or more portions of network 110. In an example, workload 401 is a workload for analyzing information associated with urban areas to identify potential locations for a business, such as a restaurant and a related market segment (e.g., types, styles, and ethnicities of food served; and inferred demographics of potential customers).

In an embodiment, an instance of workload deployment program 300 receives workload 401; identifies objects utilized by workload 401; identifies the execution paths and interactions within workload 401; and determines the locations of the nodes that store, process and/or transfer the identified objects. Based on information provided by a user and/or stored in an instance of table 250, workload deployment program 300 determines that workload 401 utilizes embedded computing entities 433, 434, and 454 (octagonal boxes). In this example, workload deployment program 300 utilizes instances of table 200 and table 250 to determine that nodes 420, 430, 440, and 450 store, process and/or transfer objects utilized during the execution of workload 401 and that nodes 430 and 450 include features that enhance the execution of embedded computing entities 433, 434, and 454.

In addition, based on an off-line execution of workload analysis program 500, workload deployment program 300 determines that workload 401 extracts different types of information (i.e., text, internet links, audio, image, and/or video, and related metadata) from various near real-time social media feeds. Workload deployment program 300 determines that a node (e.g., node 410) and embedded computing entity 414 are utilized to extract information from the near real-time social media feeds input via communication path 402. In one embodiment, workload deployment program 300 identifies a proxy node (i.e., node 410) that includes a threshold amount of hardware features that enhance the performance of embedded computing entity 414. In another embodiment, workload deployment program 300 dictates to management functions 108 a configuration for provisioning node 410. In some embodiments, if workload deployment program 300 determines that an instance of communication interface (CI) 411 includes an accelerator with a FPGA, then workload deployment program 300 can deploy (e.g., program) embedded computing entity 414 to CAPI-based instances of CI 411 with accelerators and FPGAs. In one instance, workload deployment program 300 determines that node 410 is a proxy node that includes: a plurality of flash storage devices (not shown), CI 411 represents one or more CAPI interfaces, and CI 412 represents a FC interface. In an embodiment, node 410 and node 430 are included in the same instance of system 130, as such CI 413 represents an NVMe interface that can interface with the SSD drives (not shown) of node 430 and transfer the results generated by embedded computing entity 414.

In an example, embedded computing entity 414 obtains various constraints and filters associated with workload 401, such as a city and a set of dining times, such as lunch, supper, and late night. Embedded computing entity 414 extracts and filters the near real-time social media feeds to obtain instances of object 416A (e.g., image/video objects) and/or instances of object 416B (e.g., text/audio/internet links objects). In addition, embedded computing entity 414 identifies instances metadata 415 related to the plurality of instances of object 416A and/or object 416B. Metadata 415 includes at least a time, a date, a location, an information/social media source, and a corresponding reference to an instance of object 416A and/or object 416B. Instances of metadata 415 are stored in database 422 of node 420. In some scenarios, instances of metadata 415 stored within database 422 are substantially smaller in size than the related instances of object 416A and/or object 416B, and as such instances of metadata 415 can be copied from node 420 to node 430 with minimal delays. In an embodiment, workload deployment program 300 updates embedded computing entity 433 to include an executable procedure associated with processing and/or updating instances of metadata 415 as opposed to deploying an embedded computing entity to an instance of node 420 that includes a replica of database 422 and the features associated with an embedded computing entity that an executable procedure for processing and/or updating instances of metadata 415.

In one scenario, workload deployment program 300 determines that workload 401 dictates a further analysis of the plurality of instances of object 416A and/or object 416B determined in node 410. In one embodiment, workload deployment program 300 selects node 430 to deploy embedded computing entity 433 based on the location of library 436 and at least an NVMe interface that interfaces with node 410, such as CI 413 as discussed with respect to an embodiment of node 410. In another embodiment, workload deployment program 300 selects node 430 to deploy embedded computing entity 433 based on the location of library 436, an instance of CI 431, which includes multiple communication ports and supports multiple protocols. In an example, CI 431 supports multiple protocols and at least one port is operatively coupled to data compression hardware. As such, CI 431 can transmit the results obtained by embedded computing entity 433 and instances of metadata 415 corresponding to objects obtained by analyzing instances of objects 416A and/or 416B to node 450 separately from the objects obtained by analyzing instances of objects 416A and/or 416B and instances of objects 416A and/or 416B identified for inclusion within library 446.

In some embodiment, embedded computing entity 433 includes a set of executable procedures related to extracting more granular information, such as identifying vehicles and individuals within an instance of object 416A. In some scenarios, embedded computing entity 433 further analyzes instances of object 416 to obtain additional information (e.g., generating a sub-workload) utilizing embedded computing entity 434 to compare images identified within instances of object 416A to images within library 436. Library 436 includes reference images of vehicles, apparel, and related metadata utilized to subsequently infer a demographic classification for an individual traversing a particular area. The metadata related to vehicles and apparel includes, but is not limited to: models, years, and a value of a vehicle; and type, company, designer, and cost of clothing, shoes, and accessories. In other scenarios, embedded computing entity 433 includes another set of executable procedures related to perform speech recognition, natural language processing, and semantic analysis of audio and text to identify items associated with food, dining establishments, opinions related to the food and/or dining establishments to infer a demographic classification for an individual traversing a particular area. In various scenarios, if embedded computing entity 434 does not identify references for various objects, then embedded computing entity 434 saves the unidentified objects to library 436 for offline review and classification. In a further embodiment, workload 401 dictates that if embedded computing entity 433 identifies new instances of object 416A that differ from objects within library 446 by more than a threshold amount (e.g., percentage of pertinent information between images) that newly identified objects are forwarded for storage within library 446.

In another embodiment, if library 436 is stored among SATA drives (not shown) as opposed to SDDs, then workload deployment program 300 determines whether to identify a node that includes a replica of library 436 and includes internal CI's that support a NCQ protocol in addition to one or more features utilized by embedded computing entities 433 and 434. In various embodiments, embedded computing entity 433 updates instances of metadata 415 with the metadata acquired by analyzing instances of objects 416A and/or 416B utilizing embedded computing entity 434 and replaces the corresponding instances of metadata 415 within database 422 with the updated instances of metadata 415. In other embodiments, CI 431 supports multiple protocols and at least one port is operatively coupled to data compression hardware. As such, CI 431 can transmit the results obtained by embedded computing entity 433 and instances of metadata 415 corresponding to objects obtained by analyzing instances of objects 416A and/or 416B to node 450 via communication paths different from the objects obtained by analyzing instances of objects 416A and/or 416B and instances of objects 416A and 416B identified for inclusion within library 446.

Node 440 includes library 446, a library of historic instances of objects 416A and/or 416B. Historic instances of objects 416A and/or 416B may be obtained from social media feeds, traffic-cam footage of various areas, blogs, news reports, tourist/marketing information, etc. In some embodiments, the information within library 446 is distributed among a plurality of nodes thus, workload deployment program 300 does not deploy an embedded computing entity as a threshold of objects is not identified within one or more nodes.

In an embodiment, workload deployment program 300 selects node 450 for the deployment of embedded computing entity 454 based on the location of a replica of repository 455, two or more instances of CI 451 that include CAPI interfaces, and instances of CI 452 that support NCQ for the storage devices (not shown) that comprise repository 455. Repository 455 includes databases and libraries of known businesses, active or defunct, and a plurality of information related to each known business. In an example, the plurality of information within repository 455 includes: location data, reviews and rating, menu offerings and costs, demographic focus, customer traffic levels, taxes, business expenses (e.g., labor), and reference examples of instances of object 416A, object 416B, and related metadata 415 (not shown).

In some embodiments, workload deployment program 300 determines that some instances of CI 451 include FPGAs, and programs the FPGAs executable procedures (not shown) that can intercept and route objects, filter objects, analyze metadata, and generate requests for information related to workload 401 based on the results and metadata received from node 430 prior to passing results, information, metadata, and objects to embedded computing entity 454. In some scenarios, an instance of CI 451 routes identified instances of objects 416A and 416B for inclusion within library 446. Other instances of objects 416A and 416B transferred to embedded computing entity 454 for analysis. In other scenarios, another instance of CI 451 retrieves objects from library 446 for analysis based on results and/or instances of metadata information received from node 430. In various scenarios, objects are retrieved from library 446 based on requests by embedded computing entity 454.

In an embodiment, embedded computing entity 454 is comprised of big-data analytic functions that correlates information, metadata, social media feeds, and inferred demographic information with instances of historic objects retrieved from library 446 of node 440 and the repository of information associated with known businesses. In an example, in response to workload 401 specifying a city for a perspective new restaurant, embedded computing entity 454 outputs results of potential locations within the specified city for various types of dining venues and related focus demographics. In addition, embedded computing entity 454 may further identify competitors, dining trends by time period, and success potential.

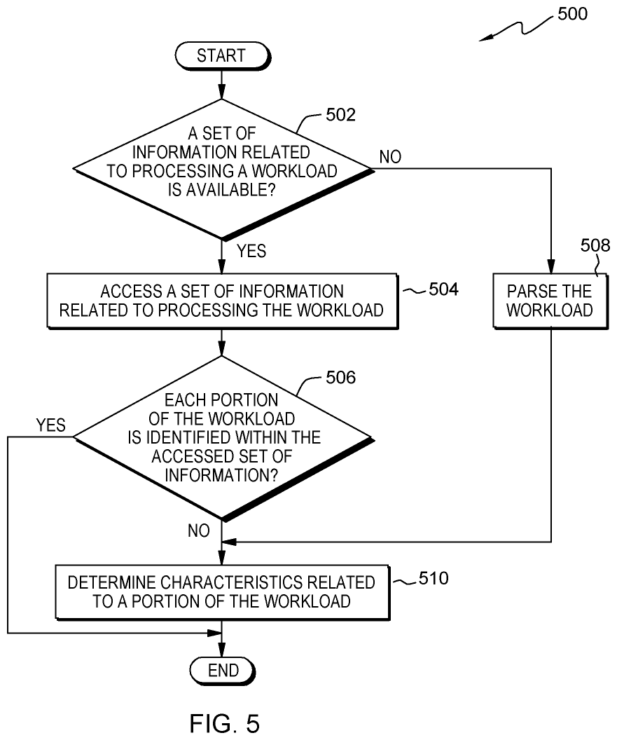

FIG. 5 is a flowchart depicting operational steps for workload analysis program 500, a program that analyzes the workflows and objects associated with a workload, in accordance with an embodiment of the present invention. In one embodiment, an instance of workload analysis program 500 is called (e.g., initiated) by an instance of workload deployment program 300. One or more instances of workload analysis program 500 can execute concurrently with an instance of workload deployment program 300. In another embodiment, workload analysis program 500 executes offline to analyze a workload. In various embodiments, workload analysis program 500 parses a workload to identify various workflows within the workload, identifies information related to the objects utilized by various workflows associated with the workload, and identifies various portions of the workload.

In decision step 502, workload analysis program 500 determines whether a set of information related to processing a workload is available. In one embodiment, workload analysis program 500 determines that a set of information related to processing a received workload or a generated sub-workload is available, based on determining that workload information 106 stores information related to the received workload, such as object information (e.g., metadata, locations, etc.), references to one or more instances of table 250, and a list of embedded computing entities and included executable procedures. In another embodiment, workload analysis program 500 determines that a set of information related to processing a received workload or a generated sub-workload is available, based on receiving the set of information for a workload in conjunction with the received workload. In one scenario, workload analysis program 500 receives the set of information related to processing a workload from a computing device that initiates the workload, such as device 120. In another scenario, workload analysis program 500 receives the set of information related to processing a workload from another computing device (not shown) that generates the workload.

Responsive to determining that a set of information related to processing a workload is available (Yes branch, decision step 502), workload analysis program 500 accesses a set of information related to processing of the workload (step 504).

In step 504, workload analysis program 500 accesses a set of information related to processing of the workload. In various embodiments, workload analysis program 500 accesses information related to a workload that includes: a plurality of utilized objects, a set of locations of utilized objects provided by workload deployment program 300, a list of embedded computing entities utilized by the workload, and functional resources/dictates of one or more embedded computing entities of the workload, such as a hierarchy of operations or identifying a set of objects associated with one or more pipelined tasks. In addition, workload analysis program 500 may identify the one or more computational algorithms and/or executable procedures included in an embedded computing entity. In one scenario, workload analysis program 500 accesses workload information 106 and/or library 104 (e.g., an instance of table 250) to obtain a set of information related to the embedded computing entities that are utilized to processes the workload. In another scenario, workload analysis program 500 communicates with a computing system that initiates a workload to obtain information associated with the workload.

In some embodiments, workload analysis program 500 accesses a set of information related to processing the workload based, at least in part, on other data, such as metadata and/or constraints associated with a workload. In one example, if workload analysis program 500 determines that the received workload is a high priority (e.g., a primary criterion) and not cost constrained, then workload analysis program 500 accesses a set of information (e.g., a processing profile, a configuration file, etc.) that includes high-performance embedded computing entities and/or a high-performance optimization scheme. In another example, workload analysis program 500 determines that the received workload is high-priority, which utilizes an embedded computing entity associated with a limited number of seats (e.g., licenses); however, workload analysis program 500 determines that no seats are currently available. In response, workload analysis program 500 does not delay executing the workload and instead accesses information within user information 105 that identifies one or more alternative embedded computing entities (e.g., a secondary criterion) that are accessible by system 102, such as within library 104.

In a further embodiment, workload analysis program 500 utilizes analysis suite 107 to analyze the aggregate performance of various embedded computing entities and performance effects of individual executable procedures. In response to analyzing a workload and various embedded computing entities, workload analysis program 500 obtains one or more additional executable procedures for inclusion within an embedded computing entity utilized during executing the workload, and/or compiles a new embedded computing entity from executable procedures.

In decision step 506, workload analysis program 500 determines whether each portion of the workload is identified within the accessed set of information associated with the workload. In one embodiment, workload analysis program 500 determines that each portion of a workload is identified within the accessed set of information based on information associated with the workload that is included in workload information 106. In another embodiment, workload analysis program 500 determines that each portion of the workload is identified based on information included with the workload. In an example, workload analysis program 500 determines that each portion of the workload is identified if each object utilized by the workload is either associated with an embedded computing entity or includes an indication that the object is not processed by an embedded computing entity.

Responsive to determining that each portion of the workload is identified within the accessed set of information (Yes branch, decision step 506), workload analysis program 500 terminates. In various embodiments, workload analysis program 500 returns control to workload deployment program 300.

Responsive to determining that each portion of the workload is not identified within the accessed set of information (No branch, decision step 506), workload analysis program 500 determines characteristics of a portion of the workload (step 510).

In step 510, workload analysis program 500 determines characteristics related to a portion of the workload. The characteristics of a portion of a workload may include classifications corresponding to the objects associated with the portion of the workload. Workload analysis program 500 may include (e.g., store) the determined characteristics for portions of a workload within information related to the workload. For example, workload analysis program 500 may include determined characteristics for portions of a workload within: user information 105, workload information 106, and/or information within storage 121 of device 120. In one embodiment, workload analysis program 500 determines one or more characteristics for a portion (e.g., one or more objects) of a workload that is not identified within the accessed set of information. In one scenario, workload analysis program 500 determines characteristics and/or constraints associated with an unidentified portion of a workload based on utilizing one or more aspects of analysis suite 107 to identify the nature of the data (i.e., objects) that is included within the unidentified portion of the workload. In one example, workload analysis program 500 may determine that the portion of the workload that is not identified includes invariant data that can be copied to any node without constraints.

In another example, workload analysis program 500 utilizes clustering algorithms to determine whether to include the unidentified portion of the workload with another portion of the workload. In some embodiments, workload analysis program 500 determines characteristics of a portion of the workload that are related to the embedded computing entities utilized to process various objects and related features that enhance the execution of the embedded computing entities.

In another embodiment, workload analysis program 500 interfaces with a user of device 120, via UI 122 to determine characteristics of a portion of a workload that is not identified. In an example, workload analysis program 500 receives an indication from a user via UI 122 to initiate one or more aspects of analysis suite 107, such as a visualization program and a spectral clustering program, so that the user can see how aspects of the workload are related and subsequently determine one or more characteristics for a portion (e.g., one or more objects) of the workload that is not identified. One such characteristic may be that multiple instances of an invariant object may be distributed among storage locations of the workload as opposed to copying a single instance of the invariant object to a central storage location; thereby reducing network traffic to access the invariant object.

Referring to decision step 502, responsive to determining that a set of information related to processing a workload in not available (No branch, decision step 502), workload analysis program 500 parses the workload (step 508).

In step 508, workload analysis program 500 parses the workload. Workload analysis program 500 can utilize various clustering functions, graph partitioning functions, machine learning programs, etc., to parse and analyze the workload in addition to analyzing (e.g., graphing, mapping) the objects, features, and hardware within the object-based storage architecture associated with networked computing environment 100. In one embodiment, workload analysis program 500 parses the workload to identify a plurality of objects that are utilized by the workload. In one scenario, workload analysis program 500 parses a workload to identify the plurality of objects that are included in the workload by utilizing one or more functions or programs of analysis suite 107, such as a graph database analysis program. In another scenario, workload analysis program 500 parses the workload to identify the plurality of objects based on content and/or metadata associated with an object. In some scenarios, workload analysis program 500 parses the workload to identify various constraints and/or interactions among objects of the workload, such as security constraints, pipelined operations, and/or other included/generated workloads (e.g., sub-workloads) within the workload.

In some embodiments in response to parsing a workload, workload analysis program 500 classifies objects related to the workload to identify executable procedures that are utilized to process the one or more objects of the workload. In one scenario, workload analysis program 500 identifies embedded computing entities based on the executable procedures utilized to process the objects of the workload. In another scenario, workload analysis program 500 identifies an embedded computing entity based on a classification associated with an object of the workload. In some scenarios, if workload analysis program 500 cannot identify embedded computing entities that include executable procedures for processing objects associated with the workload, then workload analysis program 500 utilizes various functions to compile one or more embedded computing entities from the executable procedures within library 104.

In a further embodiment, workload analysis program 500 utilizes one or more programs of analysis suite 107, which classifies objects within networked computing environment 100 to determine a general computational category and more specifically a computational operation related to an object. In one scenario, analysis suite 107 analyzes the metadata of an object, the properties of an object, and/or inspects the contents of an object to classify the object. In another scenario, if analysis suite 107 cannot directly classify an object, then analysis suite 107 utilizes machine learning or other functions to compare an unclassified object to objects that are classified and associated with an instance of table 250. Upon classifying an object, analysis suite 107 updates the metadata of an object with one or more classifications. Similarly, workload analysis program 500 can utilize analysis suite 107 to identify and classify new executable procedures for inclusion in an instance of table 250.

Referring to step 510, in other embodiments, workload analysis program 500 determines characteristics related to a portion of the workload based on information associated with parsing the workload.

In one embodiment, workload analysis program 500 determines characteristics for a portion of a parsed workload. In one scenario, workload analysis program 500 determines the size of related objects that are included in a portion of a workload. In another scenario, workload analysis program 500 determines a portion of the workload that includes security constraints. In some scenarios, workload analysis program 500 determines characteristics associated with a portion of a workload, such as rates of I/O operations and/or an encryption protocol of an object. In other scenarios, workload analysis program 500 determines characteristics of a portion of the workload, such as the classifications and/or executable procedures utilized by the objects of the portions of the workload.

In another embodiment, workload analysis program 500 determines characteristics of a portion of the workload, such as one or more embedded computing entities related to the processing of the objects included in the portion of the workload and stores the information within one or more locations, such as user information 105 and/or workload information 106. In some embodiments, workload analysis program 500 determines characteristics of a portion of the workload, such as object clustering and/or clustering of embedded computing entities. In other embodiments, workload analysis program 500 determines characteristics of a portion of the workload based on one or more user preferences, such as cost, an optimization scheme, licensed embedded computing entities, or a combination thereof. Workload analysis program 500 can obtain user preferences from user information 105. In various embodiments, workload analysis program 500 determines characteristics associated with a workload that includes feature and configuration information related to nodes that store various objects of the workload.

In a further embodiment, workload analysis program 500 utilizes one or more visualization programs to depict, via UI 122, the parsing and analysis of one or more portions of the workload to a user that initiated the workload. In an example, workload analysis program 500 presents a representation of the workload, based on one or more aspects of analysis suite 107, to a user that generates the workload. Workload analysis program 500 may receive: one or more characteristics of a portion of the workload, modifications of characteristics of a portion of the workload, and/or modification of the analysis of the workload. Alternatively, workload analysis program 500 may receive a request from a user for further analysis and/or optimizations of a portion of the workload based on changes input by the user.

FIG. 6 depicts computer system 600, which is representative of system 102, device 120, and system 130. Computer system 600 is an example of a system that includes software and data 612. Computer system 600 includes processor(s) 601, memory 602, cache 603, persistent storage 605, communications unit 607, I/O interface(s) 606, and communications fabric 604. Communications fabric 604 provides communications between memory 602, cache 603, persistent storage 605, communications unit 607, and I/O interface(s) 606. Communications fabric 604 can be implemented with any architecture designed for passing data and/or control information between processors (such as microprocessors, communications and network processors, etc.), system memory, peripheral devices, and any other hardware components within a system. For example, communications fabric 604 can be implemented with one or more buses or a crossbar switch.

Memory 602 and persistent storage 605 are computer readable storage media. In this embodiment, memory 602 includes random access memory (RAM). In general, memory 602 can include any suitable volatile or non-volatile computer readable storage media. Cache 603 is a fast memory that enhances the performance of processor(s) 601 by holding recently accessed data, and data near recently accessed data, from memory 602.

Program instructions and data used to practice embodiments of the present invention may be stored in persistent storage 605 and in memory 602 for execution by one or more of the respective processor(s) 601 via cache 603. In an embodiment, persistent storage 605 includes a magnetic hard disk drive. Alternatively, or in addition to a magnetic hard disk drive, persistent storage 605 can include a solid-state hard drive, a semiconductor storage device, a read-only memory (ROM), an erasable programmable read-only memory (EPROM), a flash memory, or any other computer readable storage media that is capable of storing program instructions or digital information. With respect to system 102 persistent storage 605 includes storage 103. With respect to device 120 persistent storage 605 includes storage 121. With respect to instances of system 130 persistent storage 605 includes a plurality of storage devices (not shown).

The media used by persistent storage 605 may also be removable. For example, a removable hard drive may be used for persistent storage 605. Other examples include optical and magnetic disks, thumb drives, and smart cards that are inserted into a drive for transfer onto another computer readable storage medium that is also part of persistent storage 605. Software and data 612 are stored in persistent storage 605 for access and/or execution by one or more of the respective processor(s) 601 via cache 603 and one or more memories of memory 602. With respect to system 102, software and data 612 includes library 104, user information 105, workload information 106, analysis suite 107, management functions 108, workload deployment program 300, workload analysis program 500, and various information, programs and databases (not shown). With respect to device 120, software and data 612 includes UI 122, and various information, such as a local instance of user information 105 and a local instance of workload information 106, and programs (not shown). With respect to instances of system 130 software and data 612 includes various programs and databases (not shown), such as a hypervisor, a storage tiering program, and a virtualization program.

Communications unit 607, in these examples, provides for communications with other data processing systems or devices, including resources of system 102, device 120, and system 130. In these examples, communications unit 607 includes one or more network interface cards. Communications unit 607 may provide communications through the use of either or both physical and wireless communications links. Program instructions and data used to practice embodiments of the present invention may be downloaded to persistent storage 605 through communications unit 607. With respect to the present invention, communication unit 607 may represent communication interfaces that include various capabilities and support multiple protocols as previously discussed.

I/O interface(s) 606 allows for input and output of data with other devices that may be connected to each computer system. For example, I/O interface(s) 606 may provide a connection to external device(s) 608, such as a keyboard, a keypad, a touch screen, and/or some other suitable input device. External device(s) 608 can also include portable computer readable storage media, such as, for example, thumb drives, portable optical or magnetic disks, and memory cards. Software and data 612 used to practice embodiments of the present invention can be stored on such portable computer readable storage media and can be loaded onto persistent storage 605 via I/O interface(s) 606. I/O interface(s) 606 also connect to display 609. With respect to the present invention, I/O interface(s) 606 may include communication interfaces that include various capabilities and support multiple protocols as previously discussed.

Display 609 provides a mechanism to display data to a user and may be, for example, a computer monitor. Display 609 can also function as a touch screen, such as the display of a tablet computer or a smartphone.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the invention. The terminology used herein was chosen to best explain the principles of the embodiment, the practical application or technical improvement over technologies found in the marketplace, or to enable others of ordinary skill in the art to understand the embodiments disclosed herein.

1. A method for managing an execution of a workload within a networked computing environment, the method comprising:
identifying, by one or more computer processors, a plurality of objects associated with a workload, the plurality of objects includes a first object;
identifying, by one or more computer processors, information corresponding to one or more nodes that store an instance of the first object, wherein the information identifies one or more hardware features of a node;
identifying, by one or more computer processors, an embedded computing entity associated with processing at least the first object;
determining, by one or more computer processors, a first node that stores an instance of the first object and includes at least one hardware feature utilized by the identified embedded computing entity;
deploying, by one or more computer processors, an instance of the identified embedded computing entity to the determined first node that stores the instance of the first object; and
executing, by one or more computer processors, the workload utilizing the embedded computing entity.

2. The method of claim 1, wherein (i) the plurality of objects are distributed among a plurality of nodes, (ii) the plurality of nodes are utilized for object-based storage within a networked computing environment, and (iii) the networked computing environment supports replication of objects among different nodes.

3. The method of claim 1, wherein (i) the identified embedded computing entity includes one or more executable procedures to process the first object, (ii) the one or more hardware features of the first node affect a performance associated with a least one executable procedure included in the identified embedded computing entity, and (iii) the identified embedded computing entity processes the first object within the first node.

4. The method of claim 1, wherein one or more objects are respectively associated with a computational operation and a corresponding computational category, wherein the computational operation and a corresponding computational category are further associated with one or more hardware features that affect a performance associated with of the computational operation.

5. The method of claim 4, wherein the computational operation is further related to an executable procedure.

6. The method of claim 1, further comprising:
maintaining, by one or more computer processors, one or more databases that cross-reference: classifications corresponding to objects, computational operations, executable procedures, embedded computing entities, and one or more hardware features that affect a performance associated with a computational operation.

7. (canceled)

8. A computer program product for managing an execution of a workload within a networked computing environment, the computer program product comprising:
one or more computer readable storage media and program instructions stored on the one or more computer readable storage media, the program instructions readable/executable by one or more computer processors:
program instructions to identify a plurality of objects associated with a workload, the plurality of objects includes a first object;
program instructions to identify information corresponding to one or more nodes that store an instance of the first object wherein the information identifies one or more hardware features of a node;
program instructions to identify an embedded computing entity associated with processing at least the first object;
program instructions to determine that a first node stores an instance of the first object and includes at least one hardware feature utilized by the identified embedded computing entity;
program instructions to deploying an instance of the identified embedded computing entity to the determined first node that stores the instance of the first object; and
program instructions to the workload utilizing the embedded computing entity.

9. The computer program product of claim 8, wherein (i) the plurality of objects are distributed among a plurality of nodes, (ii) the plurality of nodes are utilized for object-based storage within a networked computing environment, and (iii) the networked computing environment supports replication of objects among different nodes.

10. The computer program product of claim 8, wherein (i) the identified embedded computing entity includes one or more executable procedures to process the first object, (ii) the one or more hardware features of the first node affect a performance associated with a least one executable procedure included in the identified embedded computing entity, and (iii) the identified embedded computing entity processes the first object within the first node.

11. The computer program product of claim 8, wherein one or more objects are respectively associated with a computational operation and a corresponding computational category, wherein the computational operation and a corresponding computational category are further associated with one or more hardware features that affect a performance associated with of the computational operation.

12. The computer program product of claim 11, wherein the respective computational operation is further related to an executable procedure.

13. The computer program product of claim 8, further comprising:
program instructions to maintain one or more databases that cross-references: classifications corresponding to objects, computational operations, executable procedures, embedded computing entities, and one or more hardware features that affect a performance associated with a computational operation.

14. (canceled)

15. A computer system for managing an execution of a workload within a networked computing environment, the computer system comprising:
one or more computer processors;
one or more computer readable storage media; and
program instructions stored on the computer readable storage media for execution by at least one of the one or more computer processors, the program instructions comprising:
program instructions to identify a plurality of objects associated with a workload, the plurality of objects includes a first object;
program instructions to identify information corresponding to one or more nodes that store an instance of the first object wherein the information identifies one or more hardware features of a node;
program instructions to identify an embedded computing entity associated with processing at least the first object;
program instructions to determine that a first node stores an instance of the first object and includes at least one hardware feature utilized by the identified embedded computing entity;
program instructions to deploying an instance of the identified embedded computing entity to the determined first node that stores the instance of the first object; and
program instructions to the workload utilizing the embedded computing entity.

16. The computer system of claim 15, wherein (i) the plurality of objects are distributed among a plurality of nodes, (ii) the plurality of nodes are utilized for object-based storage within a networked computing environment, and (iii) the networked computing environment supports replication of objects among different nodes.

17. The computer system of claim 15, wherein (i) the identified embedded computing entity includes one or more executable procedures to process the first object, (ii) the one or more hardware features of the first node affect a performance associated with a least one executable procedure included in the identified embedded computing entity, and (iii) the identified embedded computing entity processes the first object within the first node.

18. The computer system of claim 15, wherein one or more objects are respectively associated with a computational operation and a corresponding computational category, wherein the computational operation and a corresponding computational category are further associated with one or more hardware features that affect a performance associated with the computational operation.

19. The computer system of claim 15, further comprising:
program instructions to maintain one or more databases that cross-references: classifications corresponding to objects, computational operations, executable procedures, embedded computing entities, and one or more hardware features that affect a performance associated with a computational operation.

20. (canceled)

21. The method of claim 1, wherein the one or more hardware features of the node include:
(i) one or more network interface adapters;
(ii) one or more storage device interfaces; and
(iii) one or more storage devices operatively coupled to a respective storage device interface.

22. The computer program product of claim 8, wherein the one or more hardware features of the node include:
(i) one or more network interface adapters;
(ii) one or more storage device interfaces; and
(iii) one or more storage devices operatively coupled to a respective storage device interface.

23. The computer system of claim 15, wherein the one or more hardware features of the node include:
(i) one or more network interface adapters;
(ii) one or more storage device interfaces; and
(iii) one or more storage devices operatively coupled to a respective storage device interface.
